(19) United States
(12) Patent Application Publication
(10) Pub. No.: US 2021/0354776 A1
(43) Pub. Date: Nov. 18, 2021

(54) SINGLE-TRACK LAND VEHICLE

(71) Applicant: Santé Miguel PELOT, Freiburg (DE)

(72) Inventor: Santé Miguel PELOT, Freiburg (DE)

(21) Appl. No.: 17/323,028

(22) Filed: May 18, 2021

(30) Foreign Application Priority Data
May 18, 2020 (DE) 102020113430.4

(51) Int. Cl. B62K 21/08; B62K 3/02; B62K 21/02

(52) U.S. Cl. CPC B62K 21/08; B62M 6/00; B62K 21/02; B62K 3/02

(57) ABSTRACT

The invention relates to a single-track land vehicle, which is designed, for example, as a bicycle (1), electric bike or electric scooter and has a vehicle frame (2) and a vehicle fork (5), which (5) has a fork steerer tube (4), which fork steerer tube (4) is mounted pivotably in a head tube (3) of the vehicle frame (2), wherein it is possible by means of a pivoting-angle brake or limiter (6) to at least decelerate the pivoting in of the vehicle fork (5) relative to the vehicle frame (2) and/or to define the maximum pivoting-in angle. For the single-track land vehicle according to the invention, it is characteristic that the pivoting-angle brake or limiter (6) has a tension element (7), which (7) is connected to the vehicle frame (2) via a holding element (8) held in the interior of the vehicle frame (2) or held on the vehicle frame, and that a holding counter-element (9) is provided on the tension element (7) at a distance from the holding element (8), which (9) rests or strikes against the vehicle fork (5) or against the fork steerer tube (4) when the pivoting-angle brake or limiter is activated (cf. FIG. 5).

### INCORPORATION BY REFERENCE

The following documents are incorporated herein by reference as if fully set forth: German Patent Application No. 10 2020 113 430.4, filed May 18, 2020.

### TECHNICAL FIELD

The invention relates to a single-track land vehicle, which is designed, for example, as a bicycle, electric bike or electric scooter and has a vehicle frame and a vehicle fork, which has a fork steerer tube, which fork steerer tube is mounted pivotably in a head tube of the vehicle frame, wherein it is possible by means of a pivoting-angle brake or limiter to at least decelerate the pivoting in of the vehicle fork relative to the vehicle frame and/or to define the maximum pivoting-in angle.

### BACKGROUND

Single-track land vehicles are known, for example, as bicycles, electric bikes or electric scooters in a very wide variety of embodiments. Such single-track land vehicles regularly have a vehicle frame which has a head tube. The fork steerer tube of a vehicle fork is pivotably mounted in the head tube of the vehicle frame. By means of a pivoting movement at the vehicle fork, the vehicle can be steered in one direction or the other.

The mobility of the vehicle fork can lead to problems when the vehicle is to be parked. This is because, when the vehicle is parked, there is the risk that the vehicle fork will also unintentionally pivot in, and the vehicle will be able to roll out of its parked position and tip over in this pivoted-in position of the vehicle fork.

Furthermore, there is the risk that the driver will fall during a fast and/or bumpy ride, causing the subassembly consisting of the vehicle fork, stem, handlebar and front wheel to pivot in too much and strike against the frame. If the subassembly consisting of the vehicle fork, stem, handlebar and front wheel is pivoted in to an excessive extent, there is also the risk that the brake lines or the shift forks will be pulled too tight. Stop contact of the handlebar when the vehicle fork is pivoted in can also occur during the repair or maintenance of the land vehicle.

Various pivoting-angle limiters have therefore also been created by means of which the pivoting-in angle of the vehicle fork relative to the vehicle frame can be defined or limited to a specific range. Thus, a pivoting-angle limiter is offered under the name “SteerStopper” (see website www.steerstopper.com), which can also be retrofitted to a bicycle if required. The previously known pivoting-angle limiter has a pivoted lever which is held so as to be pivotable in a vertical plane on the handlebar stem. This pivoted lever can be pivoted between a standby position and a use position, in which use position the free lever end of the pivoted lever is pivoted into a lever receptacle mounted in a fixed manner on the top tube of the bicycle frame. Since the pivoting angle is limited to zero in the position of use of this pivoting-angle limiter, this previously known pivoting-angle limiter does not prevent the problem that a cyclist may inadvertently exceed the pivoting-in angle when falling and therefore that the subassembly consisting of the vehicle fork, the stem, the handlebar and the front wheel may strike against the vehicle frame. Furthermore, there is the problem that, in the standby position, the pivoted lever is in the way of the cyclist while riding and can also accidentally engage into the position of use, with the result that the cyclist is prevented from making further steering and pivoting movements of the bicycle fork while riding.

DE 20 2012 008 119 U1 already discloses a steering stop for bicycle handlebars having a first stop element, which can be fixed to the head tube of a bicycle fork. This first stop element of the previously known steering stop interacts with a second stop element, which can be fastened to the bicycle frame, in particular to the top tube of the bicycle frame, in order to limit the turning of the handlebar. In this case, the first stop element is of annular design and serves as a covering ring of the upper steering head bearing. The second stop element, which is, in particular, produced from plastic, has two stop faces, against which the corresponding stop face of the first stop strikes in order to limit the steering angle. The second stop element is fixed, for example, by two fixing elements designed as screws. In order to avoid damage to the top tube or the head tube in the case of steering stop contact with great force, the two screws serving as fixing elements for the second stop element have a predetermined breaking point, which can be designed, for example, as an opening produced by hollow drilling. At this predetermined breaking point, the screws serving as fixing elements are weakened in such a way that, in the case of steering stop contact with excessive force, the screw connection of the second stop element is released and the previously known pivoting-angle limiter is rendered inoperative.

U.S. Pat. No. 6,003,890 A already describes a pivoting-angle limiter which comprises a stop element on the bicycle frame and a fork stop pin on the bicycle fork. When the bicycle fork is rotated beyond a predetermined position, the fork stop pin engages in the stop element, and further rotation of the bicycle fork is thereby prevented. This prevents the fork from hitting the bicycle frame. The stop element mounted on the head tube in the region of the lower steering head bearing and the fork stop pin are designed in such a way that they can also be retrofitted in a fixed manner on the relevant parts of the bicycle.

In the case of these previously known pivoting-angle limiters, there is the problem that the pivoting-in angle to the left and to the right is already defined by the manufacturer and that essential components of these previously known pivoting-angle limiters are arranged in such a way as to be visible from the outside, where, however, they can impair the appearance of the land vehicle designed, for example, as a bicycle.

### SUMMARY

The objective to be achieved is therefore that of providing a single-track vehicle having a pivoting-angle brake or limiter which effectively prevents the driver from overdoing the steering and pivoting-in movements without this pivoting-angle brake or limiter significantly impairing the appearance of the land vehicle.

In the case of the single-track land vehicle of the type mentioned at the outset, the solution to meeting this objective according to the invention consists, in particular, in that the pivoting-angle brake or limiter has a tension element which is connected to the vehicle frame via a holding element held in the interior of the vehicle frame, and in that a holding counter-element is provided on the tension element at a distance from the holding element, which counter-element rests or strikes against the vehicle fork when the pivoting-angle brake and limiter are activated.

The land vehicle according to the invention, which can be designed, for example, as a bicycle, electric bike or, alternatively, as an electric scooter, also has a vehicle frame with a head tube, in which head tube a fork steerer tube of a vehicle fork is pivotably mounted. Since a running wheel of the vehicle is held in the vehicle fork in the usual manner, and since the vehicle fork can be pivoted about the head tube of the vehicle frame, the necessary steering movements can be carried out at the vehicle fork by pivoting the vehicle fork. The land vehicle according to the invention also has a pivoting-angle brake or pivoting-angle limiter, by means of which the pivoting-in of the vehicle fork relative to the vehicle frame can at least be decelerated. It is also possible for the pivoting-angle limiter or similar steering stop to define or limit the maximum pivoting-in angle of the vehicle fork relative to the vehicle frame. For this purpose, the pivoting-angle limiter of the land vehicle according to the invention has a tension element, which is connected to the vehicle frame via a holding element held, preferably in a fixed manner, in the interior of the vehicle frame. A holding counter-element is provided on the tension element at a distance from the holding element, which counter-element rests or strikes against the vehicle fork at the latest when the maximum pivoting-in angle is reached and activates the pivoting-angle brake or limiter of the land vehicle according to the invention. The pivoting-angle brake or limiter of the land vehicle designed according to the invention has a tension element which is preferably flexible in shape. This tension element is connected to the vehicle frame via a holding element held in the interior of the vehicle frame. A holding counter-element is provided on the tension element at a distance from the holding element, which counter-element rests or strikes against the vehicle fork at the latest when the maximum pivoting-in angle is reached. Since the tension element is designed to be flexible in shape, the tension element does not further impede the steering movements at the vehicle fork as long as the pivoting-angle brake or limiter is not activated and, for this purpose, the tension element is not tensioned between the holding element and the holding counter-element. At the latest when the pivoting-angle brake or limiter of the land vehicle according to the invention reaches the defined maximum pivoting-in angle, the tension element is tensioned between the holding element and the holding counter-element in such a way that further pivoting in of the vehicle fork is no longer readily possible. The pivoting-angle brake or limiter is activated when the holding counter-element engaging on the connecting element rests or strikes against the vehicle fork and, in particular, against the fork steerer tube thereof. While one end region of the tension element rests or strikes against the vehicle fork, the other end region of the tension element engages on the holding element, which is held, preferably in a fixed manner, in the interior of the vehicle frame, for example in the tube interior of the down tube of the bicycle frame or vehicle frame. Since, on the one hand, the tension element thus engages, for example, on the fork steerer tube guided rotatably in the interior of the head tube and, on the other hand, is connected to the holding element held in the interior of the vehicle frame, the components of the pivoting-angle brake or limiter used according to the invention can be accommodated virtually invisibly in the interior of the land vehicle according to the invention. If the land vehicle according to the invention has a pivoting-angle brake, a further pivoting movement at the bicycle fork is braked in good time before the maximum pivoting-in angle is reached, and therefore a braking force counteracting the pivoting-in movement signals the reaching of the maximum pivoting-in angle in good time in advance. For this purpose, at least one damping element can be provided in the operative connection between the holding element and the holding counter-element of such a pivoting-angle brake, which damping element becomes effective from a defined tensile force acting on the tension element.

A further solution to the objective stated above envisages, in the case of the single-track land vehicle of the type mentioned at the outset, that the pivoting-angle brake or limiter has a tension element which is connected to the vehicle frame via a holding element held on the vehicle frame, and that a holding counter-element is provided on the tension element at a distance from the holding element, which counter-element rests or strikes against the fork steerer tube when the pivoting-angle brake or limiter is activated.

In the land vehicle equipped in accordance with this alternative solution, the pivoting-angle brake is mounted between the top tube and the fork steerer tube. In this case, the pivoting-in angle brake can also be protected under a cover and arranged virtually invisibly.

In order to accommodate the tension element virtually invisibly in the interior of the land vehicle according to the invention, it may be advantageous if the tension element is guided or arranged in the interior of the vehicle frame. In this case, the tension element can be guided or arranged in the tube interior of the head tube, of the down tube and/or of the top tube, for example.

To ensure that the tension element does not further impair the steering movements at the vehicle fork while the tension element is not tensioned between the holding element and the holding counter-element, it is advantageous if the tension element is designed to be flexible in shape.

In order to be able to mount the holding element in the interior of the vehicle frame in a simple manner, it is advantageous if the holding element can be fixed in the interior of the vehicle frame by means of a quick-release fastener.

Here, a preferred embodiment according to the invention envisages that the quick-release fastener has a shank which is integrally connected to the holding element and which carries a flange, and that the holding element can be fastened in an insertion opening, in particular a keyhole-shaped insertion opening, in the vehicle frame by means of the flange, preferably in a releasable manner. The quick-release fastener provided for fastening the holding element thus has a shank which is integrally connected to the holding element. This shank carries a flange by means of which the holding element can be fastened in an insertion opening, in particular a keyhole-shaped insertion opening, in the vehicle frame. Since the holding element will be exposed to great tensile forces, especially when the tension element is tensioned between the holding element and the holding counter-element, it may be sufficient if the flange which can be fastened in the keyhole-shaped insertion opening is produced from magnetic material. If the flange is produced from magnetic material, it is held securely and sufficiently firmly in the insertion opening in the vehicle frame in the no-load position.

A particularly simple but sufficiently stable embodiment according to the invention envisages that the holding counter-element is designed as a clamp which is preferably adjustable and fixable on the tension element. Since the clamp is preferably adjustable and can be fixed on the tension element in the selected position, the maximum pivoting-in angle of the pivoting-angle limiter according to the invention can also be changed and defined subsequently.

To ensure that the tension element with the pivoting-angle limiter used according to the invention can be designed to be sufficiently stable but nevertheless flexible in shape, it is advantageous if the tension element is designed as a cable, in particular as a wire or plastic cable. Here, a preferred embodiment according to the invention envisages that the tension element designed as a plastic cable is produced from PE-UHMW (ultra-high-molecular-weight polyethylene).

A particularly simple and compact embodiment according to the invention envisages that the tension element passes through a fastening opening in the fork steerer tube, and that the holding counter-element engages on the partial region of the tension element which projects into the tube interior of the fork steerer tube.

In order to make the steering movements more difficult when the pivoting-in angle at the vehicle fork comes into the range of the defined maximum value without abruptly ending the pivoting-in movement when the maximum pivoting-in angle is reached, it is advantageous if at least one damping element is provided in the operative connection between the holding element and the holding counter-element, which damping element becomes effective from a defined tensile force acting on the tension element.

Here, a particularly advantageous embodiment according to the invention envisages that at least one rubber- or spring-elastic damping element is provided between the holding element and a partial region of the tension element which projects beyond the holding element, and/or between the fork steerer tube and the holding counter-element. If the damping element is of rubber- or spring-elastic design, it is also possible to dispense with an oil/grease damper.

In order to reduce the risk of the single-track land vehicle falling when the maximum pivoting-in angle is reached, because the steering movements are abruptly prevented by the pivoting angle limiter, and in order to prevent components of the land vehicle according to the invention from being damaged as a result, it is advantageous if a predetermined breaking point is provided in the operative connection between the holding element and the holding counter-element, which breaking point is activated when a maximum tensile force acting on the tension element is exceeded.

For this purpose, a preferred exemplary embodiment according to the invention envisages that the tension element has a predetermined breaking point in its partial region arranged between the holding element and the holding counter-element, which breaking point breaks when a maximum tensile force acting on the tension element is exceeded.

### BRIEF DESCRIPTION OF THE DRAWINGS

Further developments according to the invention will be found in the following description in conjunction with the claims and the drawing. The invention is described in greater detail below with reference to a preferred exemplary embodiment.

In the drawings:

FIG. 1 shows a single-track land vehicle shown in a side view and designed here as a bicycle, in which a vehicle fork is pivotably mounted with its fork steerer tube in a head tube on a bicycle or vehicle frame,

FIG. 2 shows the land vehicle from FIG. 1, which is shown here in a partial longitudinal section, wherein the head tube of the vehicle frame, which surrounds the fork steerer tube of the vehicle fork, is shown in more detail in a partially sectioned detail illustration,

FIG. 3 shows the land vehicle from FIGS. 1 and 2 in the form of a bicycle in an exploded representation of its essential components,

FIG. 4 shows the land vehicle from FIGS. 1 to 3 in a perspective view from below the vehicle frame in the region of the head tube receiving the vehicle fork,

FIG. 5 shows the land vehicle from FIGS. 1 to 4 in a detail longitudinal section in the region of the head tube and the fork steerer tube, and

FIG. 6 shows an alternative embodiment of a land vehicle compared to the embodiments according to FIGS. 1-5 in a detail cross-section, in which alternative embodiment the tensioning element of the pivoting-angle brake or limiter is connected to the vehicle frame via a holding element held on the vehicle frame, and that a holding counter-element upon activation of the pivoting-angle brake or limiter rests or strikes against the fork steerer tube and in particular strikes the steerer tube section which protrudes outwardly beyond the head tube.

### DETAILED DESCRIPTION

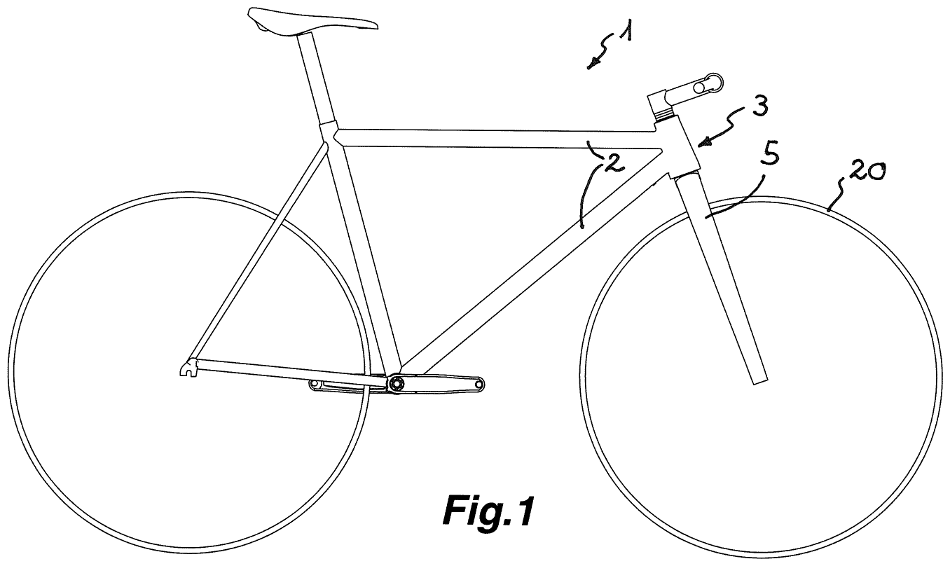

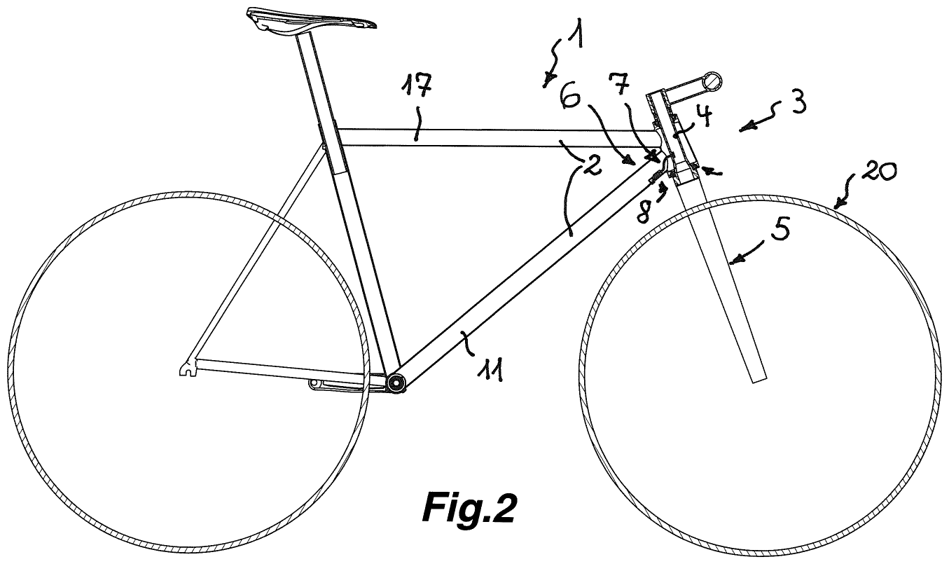

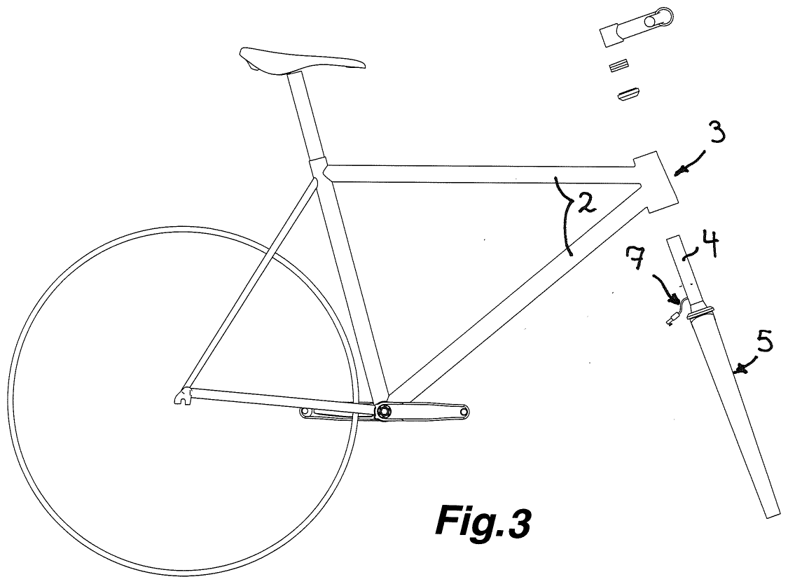

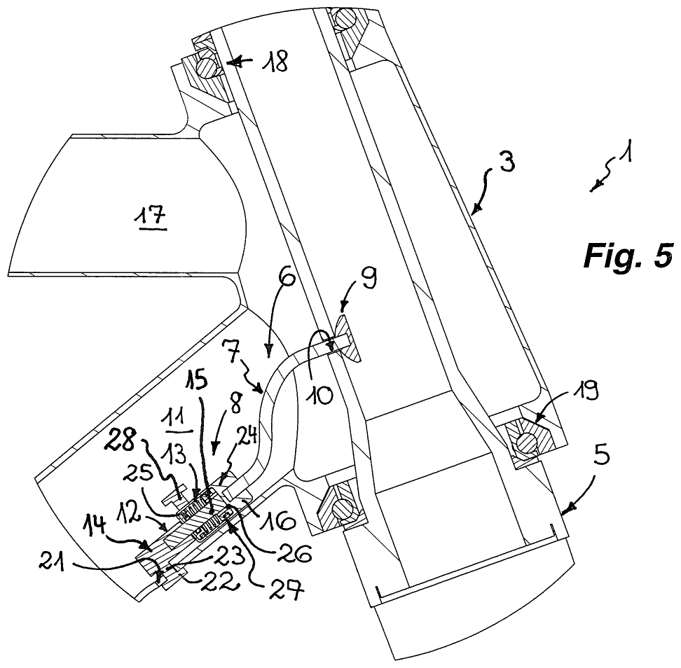

FIGS. 1 to 5 show a single-track land vehicle, which can be designed as an electric bike or electric scooter, for example, and is designed here as a bicycle 1. The bicycle 1 serving as land vehicle has a vehicle frame 2, which has a head tube 3, in which head tube 3 a fork steerer tube 4 of a vehicle fork 5 is pivotably mounted. Since a front wheel or similar running wheel 20 (shown only in FIGS. 1 and 2) of the bicycle 1 is mounted in the vehicle fork 5 in the usual manner, and since the vehicle fork 5 can be pivoted about the head tube 3 of the vehicle frame 2, the necessary steering movements can be carried out at the vehicle fork 5 by pivoting the vehicle fork 5. The bicycle 1 serving as a land vehicle has a steering stop or similar pivoting-angle limiter 6, shown in a detail longitudinal section in FIG. 5, by means of which the maximum pivoting-in angle of the vehicle fork 5 relative to the vehicle frame 2 can be defined and limited. However, it is also possible for the bicycle 1 serving as land vehicle to have a similarly acting pivoting-angle brake, with the aid of which the pivoting in of the vehicle fork 5 relative to the vehicle frame 2 can at least be decelerated.

The pivoting-angle brake or limiter 6 of the bicycle 1 illustrated here has a tension element 7, which is here designed to be flexible in shape. The tension element 7 can be designed as a chain or can have at least two subsections which are connected to one another in an articulated manner. However, the embodiment shown here, in which the tension element 7 is designed as a cable and, in particular, as a wire or plastic cable, is preferred. Here, a tension element 7 designed, for example, as a plastic cable can be produced from PE-UHMW (ultra-high-molecular-weight polyethylene). The tension element is connected to the vehicle frame 2 via a holding element 8, which is held in the interior of the vehicle frame 2, preferably in a fixed manner. A holding counter-element 9 is provided on the tension element 7 at a distance from the holding element 8, which counter-element rests or strikes against the vehicle fork 5 and, in particular, against the fork steerer tube 4 thereof, at least when the maximum pivoting-in angle is reached.

Since the tension element 7 of the pivoting-angle limiter 6 is here designed to be flexible in shape, the tension element 7 does not further impede the steering movements of the rider at the vehicle fork 5 as long as the pivoting-angle limiter is not activated and the tension element 7 is not tensioned between the holding element 8 and the holding counter-element 9. If the pivoting-angle limiter 6 of the land vehicle 1 reaches the defined maximum pivoting-in angle of the vehicle fork 5 relative to the vehicle frame 2, the tension element 7 is tensioned between the holding element 8 and the holding counter-element 9 in such a way that further pivoting in of the vehicle fork 5 is no longer readily possible. In this case, the holding counter-element 9 engaging on the tension element 7 rests or strikes against the vehicle fork 5 and, in particular, against the fork steerer tube 4 thereof.

In the detail longitudinal section shown in FIG. 5, it can be seen that the tension element 7 passes through a fastening opening 10 in the fork steerer tube 4, and that the holding counter-element 9 engages on the partial region of the tension element 7 which projects into the tube interior of the fork steerer tube 4. In this case, the holding counter-element 9 is designed as an end piece, which is held firmly and non-releasably on one free end of the tension element 7. However, the holding counter-element 9 can also be designed as a clamp which is adjustable and fixable on the tension element 7. It is also possible for the holding counter-element 9 to be designed as an eye arranged on the fork steerer tube 4.

The holding element 8 is held in the interior of the vehicle frame 2 and here in the tube interior of a down tube 11 of the vehicle frame 2, preferably in a fixed manner. Since the tension element 7 is guided in the tube interior of the head tube 3 and of the down tube 11, the components of the pivoting-angle limiter 6 can be accommodated virtually invisibly in the interior of the bicycle 1.

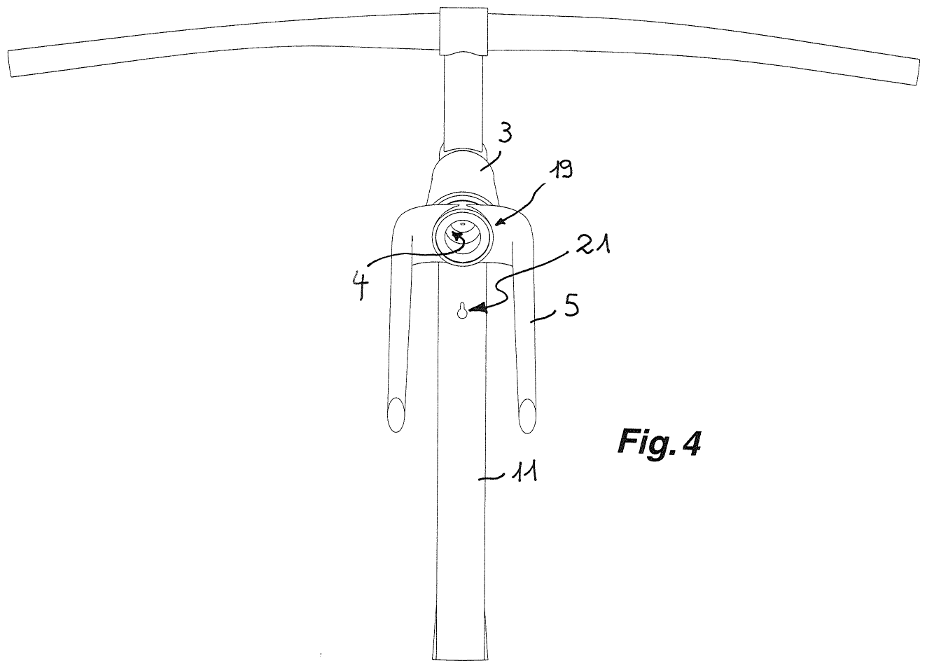

Looking at FIGS. 1 to 5 together, it can be seen that the holding element 8 can be fixed in the interior of the vehicle frame 2 by means of a quick-release fastener. As can be seen in FIG. 4, the quick-release fastener can have an insertion opening 21, in particular a keyhole-shaped insertion opening, in the vehicle frame 2, in which insertion opening 21 a flange 22 can be inserted which is connected to the holding element 8 via a shank 23. In this case, the flange 22 on the holding element 8 which can be introduced into the insertion opening 21 can be produced from magnetic material. A flange 22 produced from magnetic material can be fastened securely and sufficiently firmly in the insertion opening 21 in the vehicle frame 2.

A holding counter-element 9 is provided on the tension element 7 at a distance from the holding element 8, which counter-element rests or strikes against the vehicle fork 5 and, in particular, against the fork steerer tube 4 thereof, at least when the maximum pivoting-in angle is reached.

Since the tension element 7 of the pivoting-angle limiter 6 is designed to be flexible in shape, the tension element 7 does not further impede the steering movements of the rider at the vehicle fork 5 as long as the tension element 7 is not tensioned between the holding element 8 and the holding counter-element 9. If the pivoting-angle limiter 6 of the land vehicle 1, which in this case is designed as a bicycle, reaches the defined maximum pivoting-in angle of the vehicle fork 5 relative to the vehicle frame 2, the tension element 7 is tensioned between the holding element 8 and the holding counter-element 9 in such a way that further pivoting in of the vehicle fork 5 is no longer readily possible. In this case, the holding counter-element 9 engaging on the tension element 7 rests or strikes against the vehicle fork 5 and, in particular, against the fork steerer tube 4 thereof.

In the detail longitudinal section shown in FIG. 5, it can be seen that the tension element 7 passes through a fastening opening 10 in the fork steerer tube 4, and that the holding counter-element 9 engages on the partial region of the tension element 7 which projects into the tube interior of the fork steerer tube 4. In this case, the holding counter-element 9 is designed as an end piece, which is held firmly and non-releasably on one free end of the tension element 7. However, the holding counter-element 9 can also be designed as a clamp which is adjustable and fixable on the tension element 7.

The holding element 8 is held in the interior of the vehicle frame 2 and here in the tube interior of a down tube 11 of the vehicle frame 2, preferably in a fixed manner. Since the tension element 7 is guided in the interior of the vehicle frame 2 and, in this case, in the tube interior of the head tube 3 and of the down tube 11, the components of the pivoting-angle limiter 6 can be accommodated virtually invisibly in the interior of the bicycle 1 serving as a land vehicle.

The exemplary embodiment illustrated in more detail in FIG. 5 is also designed as a pivoting-angle brake. For this purpose, at least one damping element 12 is provided in the operative connection between the holding element 8 and the holding counter-element 9, which damping element 12 becomes effective from a defined tensile force acting on the tension element 7. For this purpose, at least one rubber- or spring-elastic damping element 12 is provided in the exemplary embodiment illustrated here. In this case, this damping element 12 is formed by a helical spring 13, which can also cooperate with an oil- or grease-filled damper 24, similar to a cabinet hinge damper. Such a damper 24 can have, for example, a piston 27 which is guided movably in a cylinder and displaces a damper medium consisting of grease and/or oil from a first chamber 25 into a second chamber 26. The grease or oil serving as damping medium flows from the first chamber 25 into the second chamber 26. After a jerky movement, the spring coil 13 presses the piston 27 back and the damping medium flows from the second chamber 26 back into the first chamber 25. The pivoting-angle brake or limiter 6 can have a locking element 28 which, when actuated, locks the pivoting-angle brake or limiter 6 in a maintenance or parking position. In this maintenance or parking position, the pivoting-angle limiter 6 locked by means of the locking element 28 holds the vehicle fork 5 at the defined pivoting angle, when, for example, the stem is dismantled during maintenance work or the land vehicle, in this case designed as a bicycle 1, is parked.

In FIG. 5, it can be seen that the holding element 8 has a base 14, which is fixedly mounted on the tube interior of the down tube 11. The base 14 carries an anchor element 15, which is of approximately T-shaped design here, on which anchor element 15 a slide 16 is movably guided. The slide 16 is held on the anchor element 15 so as to be movable between two sliding end positions. The end region of the tension element 7 remote from the holding counter-element 9 engages on the slide 16. As a result of the steering movements, a tensile force is exerted on the slide 16 via the tension element 7, which tensile force moves the slide 16 from its one sliding end position into the other sliding end position against the restoring force of the helical spring 13.

A predetermined breaking point can be provided in the operative connection between the holding element 8 and the holding counter-element 9, which predetermined breaking point is activated when a tensile force acting on the tension element 7 is exceeded. This predetermined breaking point can be provided, for example, in the partial region of the tension element 7 which is arranged between the holding element 8 and the holding counter-element 9. However, it is also possible for the tension element 7 to be released from the holding counter-element 9 or from the holding element 8 and its slide 16 when a defined maximum tensile force is exceeded, the connection point between the tension element 7 and the holding element 8 or the holding counter-element 9 thus forming the predetermined breaking point.

In the detail longitudinal section in FIG. 5, the bicycle frame 2 can be seen in the region of its head tube 3. It can be clearly seen that a top tube 17 of the vehicle frame 2 engages on the head tube 3 above the down tube 11. In FIG. 5, it can also be seen that the fork steerer tube 4 of the vehicle fork 5 is rotatably mounted in the head tube 3 by means of an upper steering head bearing 18 and a lower steering head bearing 19.

In the land vehicle illustrated in FIGS. 1-5, the tension element 7 of the pivoting-angle brake or limiter 6 is connected to the vehicle frame 2 via a holding element 8 which is held in the interior of the vehicle frame 2, wherein the holding counter-element 9 rests or strikes against the vehicle fork 5 when the pivoting-angle brake or limiter 6 is activated.

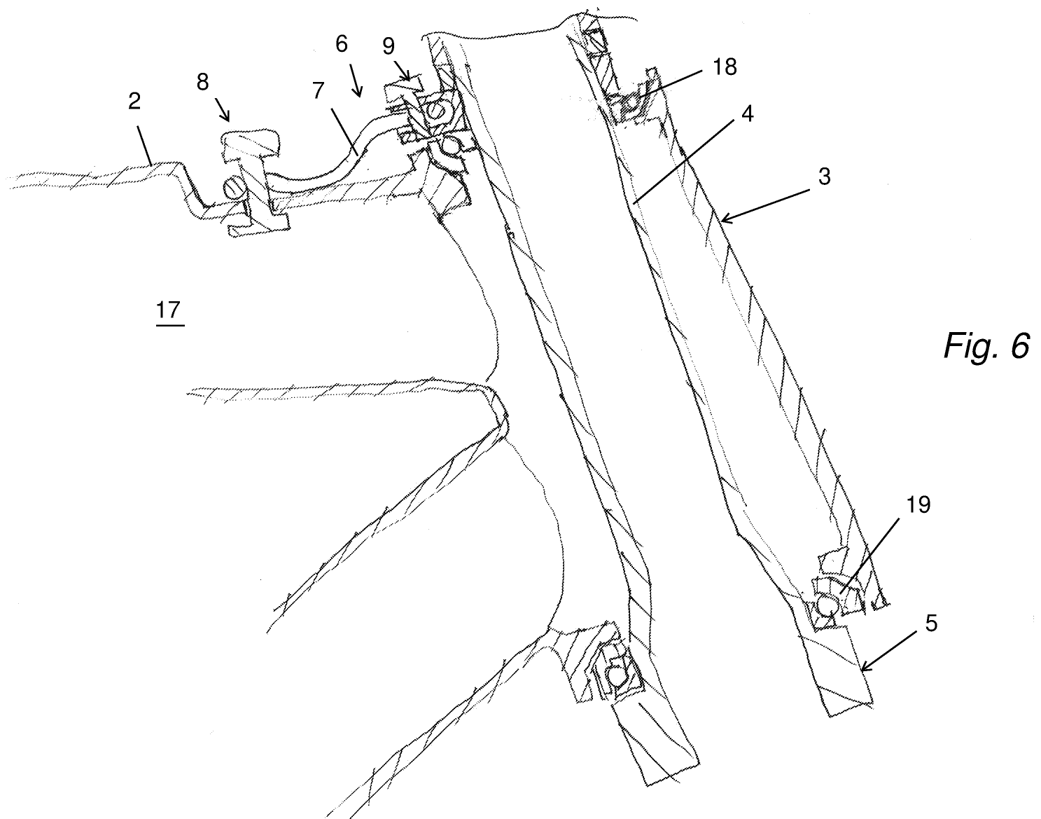

In contrast, an alternative embodiment shown in the partially sectioned detailed view according to FIG. 6 provides that the tension element 7 is connected to the vehicle frame 2 via a holding element 8, which holding element 8 is held on the vehicle frame 2. In this alternative pivoting-angle brake or limiter 6 according to FIG. 6, when the pivoting-angle brake or limiter 6 is activated, the holding counter-element 9 lies or strikes against the fork steerer tube 4 and in particular on its fork steerer tube section protruding outward beyond the head tube 3.

### LIST OF REFERENCE SIGNS

1 bicycle

2 vehicle frame

3 head tube

4 fork steerer tube

5 vehicle fork

6 pivoting-angle limiter

7 tension

8 holding element

9 holding counter-element

10 fastening opening

11 down tube

12 damping element

13 helical spring

14 base

15 anchor element

16 slide

17 top tube

18 upper steering head bearing

19 lower steering head bearing

20 running or front wheel

21 insertion opening

22 flange

23 shank

24 damper

25 first chamber

26 second chamber

27 piston

28 locking element

1. A single-track land vehicle, comprising:
a vehicle frame (2);
a vehicle fork (5) that includes a fork steerer tube (4), the fork steerer tube (4) is mounted pivotably in a head tube (3) of the vehicle frame (2), and
a pivoting-angle brake or limiter (6) configured to at least one of decelerate a pivoting in of the vehicle fork (5) relative to the vehicle frame (2) or define a maximum pivoting-in angle, the pivoting-angle brake or limiter (6) including:
a tension element (7) that is connected to the vehicle frame (2) via a holding element (8) held in an interior of the vehicle frame (2), and
a holding counter-element (9) on the tension element (7) located at a distance from the holding element (8), the holding counter-element (9) being configured to rest or strike against the vehicle fork (5) when the pivoting-angle brake or limiter (6) is activated.

2. The single-track land vehicle of claim 1, wherein the single-track land vehicle comprises a bicycle (1), an electric bike or an electric scooter.

3. The single-track land vehicle as claimed in claim 1, wherein the holding counter-element (9) rests or strikes against the fork steerer tube (4) in a partial region of the fork steerer tube (4) arranged within the head tube (3).

4. The single-track land vehicle as claimed in claim 1, wherein the tension element (7) is flexible in shape.

5. The single-track land vehicle as claimed in claim 1, wherein the tension element (7) is guided or arranged in the interior of the vehicle frame (2).

6. The single-track land vehicle as claimed in claim 1, wherein the holding element (8) is fixed in the interior of the vehicle frame (2) by a quick-release fastener or a locking element (28).

7. The single-track land vehicle as claimed in claim 6, wherein the quick-release fastener has a shank (23) which is integrally connected to the holding element (8) and which carries a flange (22), and the holding element (8) is fastenable in an insertion opening (21) in the vehicle frame (2) by the flange (22).

8. The single-track land vehicle as claimed in claim 7, wherein the flange (22) is formed of magnetic material.

9. The single-track land vehicle as claimed in claim 1, wherein the holding counter-element (9) comprises a clamp which is adjustable and fixable on the tension element (7).

10. The single-track land vehicle as claimed in claim 1, wherein the tension element (7) comprises a cable.

11. The single-track land vehicle as claimed in claim 10, wherein the tension element (7) comprises a plastic cable formed from PE-UHMW (ultra-high-molecular-weight polyethylene).

12. The single-track land vehicle as claimed in claim 1, wherein the tension element (7) passes through a fastening opening (10) in the fork steerer tube (4), and the holding counter-element (9) engages on a partial region of the tension element (7) which projects into a tube interior of the fork steerer tube (4).

13. The single-track land vehicle as claimed in claim 1, further comprising at least one damping element (12) in operative connection between the holding element (8) and the holding counter-element (9), and the damping element (12) becomes effective from a defined tensile force acting on the tension element (7).

14. The single-track land vehicle as claimed in claim 1, further comprising at least one rubber- or spring-elastic damping element (12) at least one of (a) between the holding element (8) and a partial region of the tension element (7) which projects beyond the holding element (8), or (b) between the fork steerer tube (4) and the holding counter-element (9).

15. The single-track land vehicle as claimed in claim 1, wherein a predetermined breaking point is provided in the operative connection between the holding element (8) and the holding counter-element (9), said breaking point is adapted to be activated when a defined tensile force acting on the tension element (7) is exceeded.

16. A single-track land vehicle comprising:
a vehicle frame;
a vehicle fork, which has a fork steerer tube that is mounted pivotably in a head tube of the vehicle frame; and
a pivoting-angle brake or limiter configured to at least one of decelerate the pivoting in of the vehicle fork relative to the vehicle frame or define a maximum pivoting-in angle, the pivoting-angle brake or limiter including:
a tension element connected to the vehicle frame via a holding element held on the vehicle frame, and
a holding counter-element on the tension element located at a distance from the holding element, the holding counter-element being configured to rest or strike against the fork steerer tube when the pivoting-angle brake or limiter is activated.

17. The single-track land vehicle of claim 16, wherein the single-track land vehicle comprises a bicycle (1), an electric bike or a electric scooter.
